(19) United States
(12) Patent Application Publication
(10) Pub. No.: US 2012/0032909 A1
(43) Pub. Date: Feb. 9, 2012

(54) POWER SAVING TOUCH ELECTRONIC BOOK

(76) Inventor: Tzu-Ming WANG, Fongshan City (TW)

(21) Appl. No.: 12/851,721

(22) Filed: Aug. 6, 2010

(51) Int. Cl. G06F 3/044; G06F 3/041

(52) U.S. Cl. 345/174; 345/173

(57) ABSTRACT

A power saving touch electronic book, operated by a stylus, including: a proximity sensing unit, used to output an enable signal by detecting the distance the stylus is away from it, wherein the enable signal is at a first level when the distance is not larger than a predetermined threshold, and at a second level when the distance is larger than the predetermined threshold; a control unit, having an enable input end and a touch sensing interface, the enable input being coupled with the enable signal, and the touch sensing interface having a power supply output terminal which will output a power for touch sensing when the enable signal changes state from the second level to the first level; and a touch screen, coupled with the touch sensing interface to access the power for touch sensing and thereby provide a touch sensing function.

### BACKGROUND OF THE INVENTION

1. Field of the Invention

The present invention relates to an electronic book, especially to a power saving touch electronic book, which enables/disables a touch sensing function depending on the distance a stylus is away from the power saving touch electronic book.

2. Description of the Related Art

As the touch panel is easy to operate, it has been widely integrated in portable electronic devices—such as electronic books, to offer touch input function. However, the touch sensing module of a general touch electronic book is commonly designed to keep consuming power even if there is no touch input activity. This will not only reduce the battery operation time, but also contradict the green trend. In view of this problem, the present invention proposes a novel touch electronic book architecture, which can determine whether to enable a touch sensing function according to the distance a stylus is away from the electronic book, and thereby avoid unnecessary power consumption.

### SUMMARY OF THE INVENTION

One objective of the present invention is to disclose a power saving touch electronic book, which can determine whether to enable a touch sensing function according to the distance a stylus is away from the electronic book—the distance being sensed by a proximity sensor, and thereby avoid unnecessary power consumption.

Another objective of the present invention is to disclose a power saving touch electronic book, which can determine whether to disable the touch sensing function according to an idle time tracked by a control unit, and thereby avoid unnecessary power consumption without interfering with the user's normal touch operation.

To attain the foregoing objectives, the present invention proposes a power saving touch electronic book, operated by a stylus. The power saving touch electronic book includes a proximity sensing unit, a control unit, and a touch screen.

The proximity sensing unit is used to output an enable signal by detecting the distance the stylus is away from it, wherein the enable signal is at a first level, for example a high level, when the distance is not larger than a predetermined threshold, and at a second level, for example a low level, when the distance is larger than the predetermined threshold.

The control unit, having an enable input end, a touch sensing interface, and a timer. The enable input end is coupled with the enable signal. The touch sensing interface has a power supply output terminal and a sensing signal input terminal The timer is used to track the idle time of touch input. When the enable signal changes state from the second level to the first level, the control unit will output a power for touch sensing via the power supply output terminal, and read a touch sensing signal via the sensing signal input terminal to receive a touch input. The timer will start counting from zero after the control unit has detected an event that the enable signal changes state from the second level to the first level. During the counting period, the timer will restart counting from zero if the control unit receives any touch input. When the lasting time, for which the control unit doesn't detect the event that the enable signal changes state from the second level to the first level and doesn't receive any touch operation, reaches a predetermined value of idle time, that is, the counting value of the timer reaches the predetermined value of idle time, the control unit will shut down the power for touch sensing. The predetermined value of idle time has a default value and can be changed by a touch operation on the touch screen using the stylus.

The touch screen is coupled with the touch sensing interface to access the power for touch sensing and output the touch sensing signal in response to a touch operation using the stylus.

Thanks to the novel design, the present invention has the following functions:

1. The electronic book of the present invention will enable a touch sensing function and make a timer start counting from zero when a proximity sensing unit detects the distance a stylus is away from it changing from larger to smaller than a predetermined distance.

2. The electronic book of the present invention allows users to enter a predetermined value of idle time via a touch operation on a touch screen using a stylus, wherein the predetermined value of idle time has a default value.

3. The electronic book of the present invention can disable the touch sensing function when the time for which no touch input takes place reaches the predetermined value of idle time.

That is, the design of the present invention can avoid unnecessary power consumption without interfering with the user's normal touch operation.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 illustrates the block diagram of a power saving touch electronic book according to a preferred embodiment of the present invention.

FIG. 2 illustrates the scenario that the stylus is at a distance of d relative to the power saving touch electronic book.

### DETAILED DESCRIPTION OF THE PREFERRED EMBODIMENTS

The present invention will be described in more detail hereinafter with reference to the accompanying drawings that show the preferred embodiment of the invention.

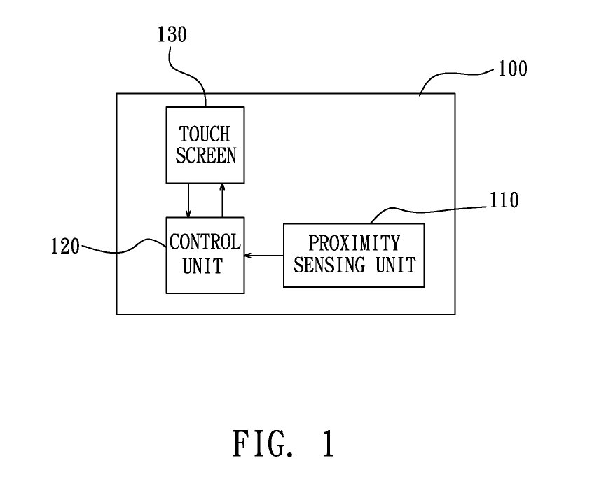

Please refer to FIG. 1, which illustrates the block diagram of a power saving touch electronic book according to a preferred embodiment of the present invention. As illustrated in FIG. 1, the power saving touch electronic book 100 includes a proximity sensing unit 110, a control unit 120, and a touch screen 130.

The proximity sensing unit 110 is used to generate an enable signal—having a first level, for example a high level, and a second level, for example a low level. When the distance from the proximity sensing unit 110 to a stylus (not illustrated in FIG. 1) is not larger than a predetermined value, the enable signal is at the first level; when the distance from the proximity sensing unit 110 to the stylus is larger than the predetermined value, the enable signal is at the second level. The proximity sensing unit 110 can be implemented with a magnetic sensor, a supersonic sensor, or a capacitive proximity sensor. As these sensors are well known, their operation principles are not to be elaborated upon here.

The control unit 120, coupled with the proximity sensing unit 110 and the touch screen 130, has an enable input end, a touch sensing interface, and a timer. When the enable signal changes state from the second level to the first level, the control unit 120 will make the timer start counting from zero, output a power for touch sensing to the touch screen 130 via the touch sensing interface, and read a touch sensing signal from the touch screen 130 via the touch sensing interface to receive a touch input. During the counting period, if the control unit 120 receives any touch input, the timer will restart counting from zero. When the time for which the control unit 120 doesn't detect the event that the enable signal changes state from the second level to the first level reaches a predetermined value of idle time, that is, the counting value of the timer reaches the predetermined value of idle time, the control unit 120 will shut down the power for touch sensing. The control unit 120 is preferably a micro controller, having a register for storing the predetermined value of idle time, wherein the register has a default value, and its content can be changed by a touch operation on the touch screen 130 using the stylus.

The touch screen 130 has an electronic paper display and a touch module. The electronic paper display receives the data of an image via an electronic paper input port and displays the image on a panel. The touch module accesses the power for touch sensing via the touch sensing interface, and outputs the touch sensing signal via the touch sensing interface in response to the touch operation using the stylus. The electronic paper display can be an electrophoresis display, a MEMS (Micro Electro Mechanical Systems) display, a cholesteric liquid crystal display, an electrowetting display, or a liquid crystal display, and the electronic paper input port is preferably a USB connection port. The touch module can be a resistive touch module, a capacitive touch module, an optics touch module, a surface acoustic wave touch module, or a force sensing touch module.

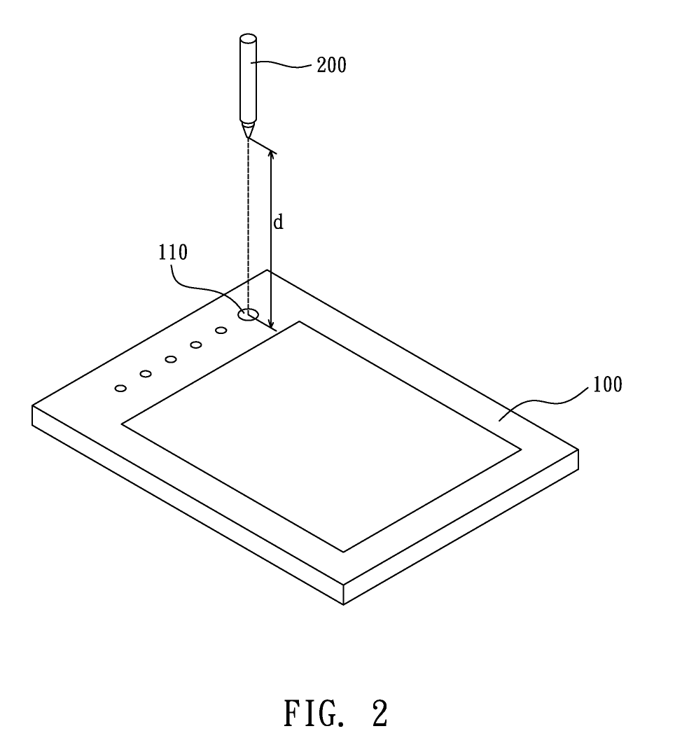

Please refer to FIG. 2, which illustrates the scenario that the stylus 200 is at a distance of d relative to the power saving touch electronic book 100.

The power saving touch electronic book of the present invention has three states when in operation:

State one: when the distance between the stylus 200 and the proximity sensing unit 110 changes from larger than d to smaller than d, the power saving touch electronic book will enter the state one, in which the timer starts counting from zero and the power for touch sensing is enabled.

State two: the power saving touch electronic book will enter the state two each time when there is a touch operation on the touch screen 130 using the stylus 200. When in the state two, the timer will restart counting from zero, and the power for touch sensing will be kept enabled. The state two will last until the counting value of the timer reaches a predetermined value of idle time.

State three: the power saving touch electronic book will enter the state three when the counting value of the timer reaches the predetermined value of idle time. When in the state three, the power for touch sensing will be disabled to save power consumption.

In conclusion, the power saving touch electronic book of the present invention not only can determine when to enable a touch sensing function as to avoid unnecessary power consumption, but also can determine when to disable the touch sensing function as not to interfere with the user's normal touch operation.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A power saving touch electronic book, operated by a stylus, comprising:
a proximity sensing unit, used to output an enable signal according to the distance said stylus is away from said proximity sensing unit, wherein said enable signal is at a first level when said distance is not larger than a predetermined threshold, and at a second level when said distance is larger than said predetermined threshold;
a control unit, having an enable input end and a touch sensing interface, said enable input end coupled with said enable signal, said touch sensing interface being used to output a power for touch sensing and receive a touch sensing signal when said enable signal changes state from said second level to said first level; and
a touch screen, coupled with said touch sensing interface to access said power for touch sensing and provide said touch sensing signal in response to a touch operation using said stylus.

2. The power saving touch electronic book as claim 1, wherein said control unit further comprises:
a register, used to store a predetermined value of idle time, having a default value, and the content of said register being alterable by a touch operation on said touch screen using said stylus; and
a timer, which will start counting from an initial value when said control unit receives said touch sensing signal or detects an event that said enable signal changes state from said second level to said first level, wherein said control unit will shut down said power for touch sensing when the counting value of said timer reaches said predetermined value of idle time.

3. The power saving touch electronic book as claim 1, wherein said touch screen comprises a touch module selected from the group consisting of a resistive touch module, a capacitive touch module, an optics touch module, a surface acoustic wave touch module, and a force sensing touch module.

4. The power saving touch electronic book as claim 1, wherein said touch screen comprises a display selected from the group consisting of an electrophoresis display, a MEMS display, a cholesteric liquid crystal display, an electrowetting display, and a liquid crystal display.

5. The power saving touch electronic book as claim 2, wherein said control unit is implemented with a micro controller.

6. The power saving touch electronic book as claim 1, wherein said proximity sensing unit comprises a sensor selected from the group consisting of a magnetic sensor, a supersonic sensor, and a capacitive proximity sensor.
